(19) United States
(12) Patent Application Publication
(10) Pub. No.: US 2002/0190075 A1
(43) Pub. Date: Dec. 19, 2002

(54) Multiple dispensing container system

(76) Inventors: Reinhold Weldi, Teesdorf (AT); Theodor Mautner Markhof, Vienna (AT)

Correspondence Address: FOLEY HOAG LLP, PATENT GROUP, WORLD TRADE CENTER WEST, 155 SEAPORT BOULEVARD, BOSTON, MA, 02110-2600, US

(21) Appl. No.: 10/150,699

(22) Filed: May 17, 2002

Related U.S. Application Data
(60) Provisional application No. 60/291,863, filed on May 18, 2001.

(51) Int. Cl. G07F 11/00

(52) U.S. Cl. 221/69

(57) ABSTRACT

A multiple dispensing container system includes an external housing and a container insert disposed therein. The external housing may be formed from an upper container unit section and a lower container unit section that releasably attach to each other. The container insert is provided with a plurality of cavities adapted for holding and releasing small articles, for example pills or medications.

### REFERENCE TO RELATED APPLICATION

This application claims priority to U.S. Provisional Patent Application Serial No. 60/291,863 filed on May 18, 2001. The contents of the aforementioned application are hereby incorporated by reference. This application also is related to European Patent Application No. 02010550.8, the contents of which is incorporated by reference.

### FIELD OF THE INVENTION

The invention relates to a system for organizing and dispensing medication or other small articles such as pills or tablets.

### BACKGROUND

Management of patients with complex diseases or multiple disease entities may require the administration of medication on a complicated schedule. A number of pill dispensers and similar devices exist that provide timed dispensation of medications. However, there remains a need in the art for a system adaptable to the administration of multiple different drugs at different times during a day, a week, or some other interval. Their further remains a need in the art for a flexible dispensing system that can be adjusted to adapt to varying administration requirements. A convenient, easy to handle medication dispenser would be useful even for those patients whose medication schedules are not particularly complicated.

The need for such a system is heightened by the demographics of the population, where elderly patients may require complex medication schedules and overall organization of their medication regime. Furthermore, it is desirable that a medication system be usable by visually impaired patients. In addition, it is recognized that a secure mechanism for opening and closing the dispensing system at appropriate times would be useful. A convenient, easy to handle method of opening and closing the dispensing system is particularly advantageous.

### SUMMARY

Described herein is an easy-to-use, multi-use dispensing container for storing and sequentially dispensing solid contents such as medications, foods, and other commercial products. Depending on the dimensions of the container and compartments within the container, as well as the size of the dispensing opening(s), the dimensions of the contents may be varied in size and shape. Defined single or multiple dispensing may be preformed at each dispensing opening, depending on the compartment used. The OPEN and CLOSED positions of the dispensing container are fixed by a catch lock system.

The small dimensions and dispensing function make the container ideal for everyday transport in a handbag, jacket, or pocket. The dispensing container consists essentially of three individual parts joined to two main parts: an upper part made of tinplate varnished on both sides, and a lower part made of polypropylene having a varnished tin plate disk inserted from the outside. The design allows both upper and lower parts to be easily put together and pulled apart. Depending on the configuration of the catch pins, the two parts may be counter-rotated in two directions, or only in one direction, and engage in provided fixed positions such as OPEN and CLOSED. The upper and lower parts may be put together and pulled apart in any position. However, and INITIAL POSITION is provided with a visible, tactile notch. This position is located between the start and the end of a complete rotation, in the CLOSED position. The notches facilitate putting the container together, especially for the visually impaired.

Through appropriate shaping and choice of materials, the dispensing container offers ample printing options for putting information and graphic designs on the container.

One example of a possible use of the dispensing container is for medications, with fixed dispensing times such as morning, midday, and evening. The particular pill of interest may be removed by simply rotating the upper and lower parts of the dispensing opening is uncovered and locked into place. After removal, the upper and lower parts of the dispensing container are further rotated by one catch point to close the dispensing container.

The individual dispensing openings may be characterized by different numbers of raised bumps or other tactilely perceptible markings on the gripping edge of the lower part of the dispensing container, which allow the visually impaired to easily identify them by touch. For example, a different numbers of bumps for each dispensing opening (for example, 0; 00; 000=morning, midday, and evening) enable the desired dispensing time to be freely defined. The dispensing container may be filled from the side, into the individual dispensing compartments, or directly into the individual compartments of the lower part by pulling off the upper and lower parts.

In one aspect, a multiple dispensing container system is provided for dispensing small articles. The system may include an individual dispensing unit having upper container unit section, a lower container unit section and a container insert. In one embodiment, the upper container unit section and the lower container unit section may be releasably attachable to each other to form an external housing. The container insert may be removably insertable into the external housing. The external housing may have at least one dispensing opening. Additionally, the container insert may have a plurality of cavities for retaining small articles with a preselected number of small articles being disposed in each cavity. Each cavity of the container insert may have an exit aperture extending through an outer circumferential aspect of the container insert. The exit aperture may be alignable with the at least one dispensing opening of the external housing. In certain embodiments, the external housing may be rotatable relative to the container insert. The relative rotation means that either the external housing is rotatable of the container insert remains stationary, the container insert rotates while the external housing remains stationary, or both components rotate with respect to each other. In certain embodiments, a latching mechanism may be provided to direct relative rotation in only one rotational direction. A multiple dispensing container system may comprise a plurality of individual dispensing units, each removably fixable to others. These individual dispensing units may be identical or dimensionally different. In one embodiment, either the upper container unit section or the lower container unit section may bear an embossing. In certain embodiments, a top cover may be provided that is removably attachable to the upper container unit section and a bottom cover may be provided that is removably attachable to the lower container unit section. In another embodiment, an annular ring may be provided that is insertable between an individual dispensing unit and at least one of the top cover and a bottom cover. In certain embodiments, at least one of the cavities within the container insert has an open top. In certain of these embodiments, the container insert may be removably coverable with a cover that has at least one radially disposed divider wall which can be inserted into at least one of the cavities to divide it into subcavities. The cavities of the container insert may also be divided into subcavities by other means.

### BRIEF DESCRIPTION OF THE FIGURES

The various properties and advantageous features of a multiple dispensing container system will be appreciated more fully from the following further description thereof, with reference to the accompanying drawings wherein like numbers represent like structures.

FIG. 1 shows an embodiment of a multiple dispensing container system.

FIG. 2A shows a lateral projection view of a multiple dispensing container system.

FIG. 2B shows a lateral projection view of a multiple dispensing container system.

FIG. 3 shows a lateral projection view of an external component of a multiple dispensing container system.

FIG. 4 shows a lateral projection view of another external component of a multiple dispensing container system.

FIG. 5 shows a top projection view of the component shown in FIG. 2.

FIG. 6 shows a lateral projection view of a top component and a bottom component of a multiple dispensing container system.

FIG. 7 shows a cross-section of a portion of the multiple dispensing container system shown in FIG. 2A.

FIG. 8 shows a top projection view of an internal component of a multiple dispensing container system.

FIG. 9 shows a cross-section of the component shown in FIG. 8.

FIG. 10 shows a partial cross-section of a multiple dispensing container system.

FIG. 11 shows a top projection view of an internal component of a multiple dispensing container system.

FIG. 12 shows a top projection view of an internal component of a multiple dispensing container system.

FIG. 13 shows a top projection view of an internal component of a multiple dispensing container system.

FIG. 14 shows a top projection view of a portion of a multiple dispensing container system.

### DETAILED DESCRIPTION

With reference to the following figures, a detailed description is provided for embodiments of a multiple dispensing container system. In certain embodiments, individual multiple dispensing containers may be joined together and disconnected again for particular applications. In certain embodiments, individual multiple dispensing containers may be refilled. Containers may be opened and closed by simple rotation of components of the system, as will be described below in more detail. In certain embodiments, tactile information may be provided on the external aspect o f multiple dispensing containers, for example for the visually impaired. Desirably, the visually impaired user may be able to determine, for example, opening and closing positions for components of the system. The system provides flexibility, so that there can be a varying number of openings for access to the container's contents, depending upon the application. Desirably, opening and closing of the container takes place by rotation in only one rotational direction, and the open and closed positions are securely locked. By changing the diameter and the height of a multiple dispenser container, a container may be suitable for larger or smaller fill quantities. Similarly, the amount of fill for any cavity in the container may be varied as needed for a particular application.

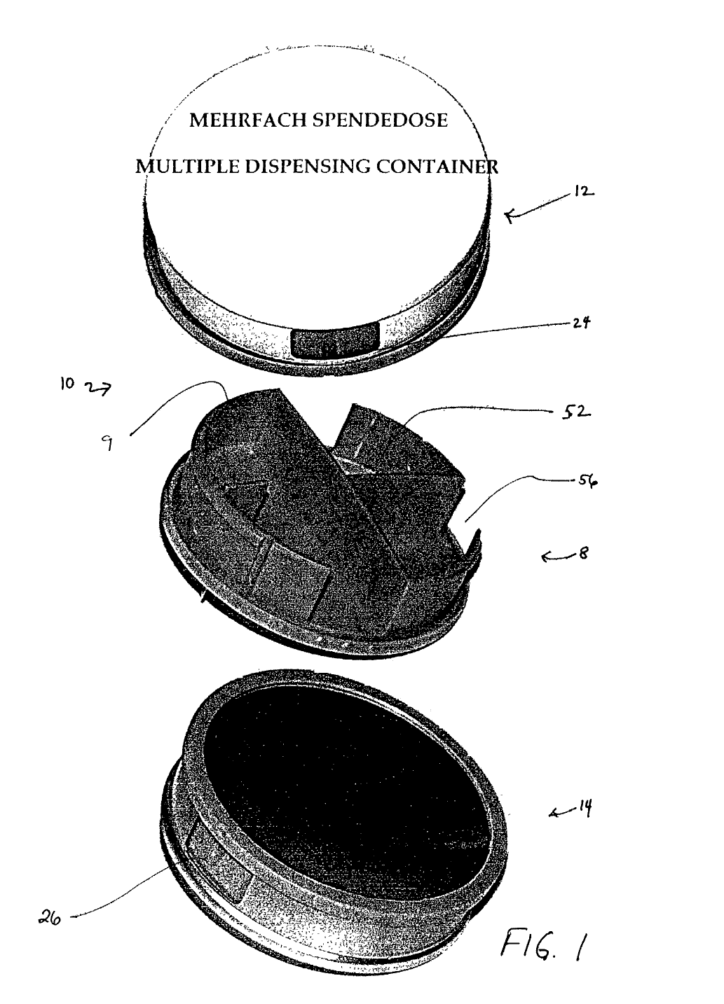

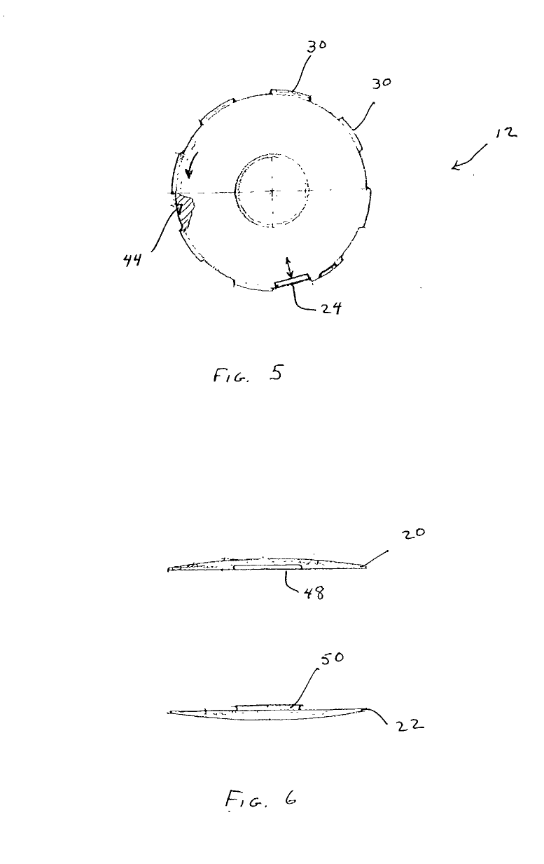

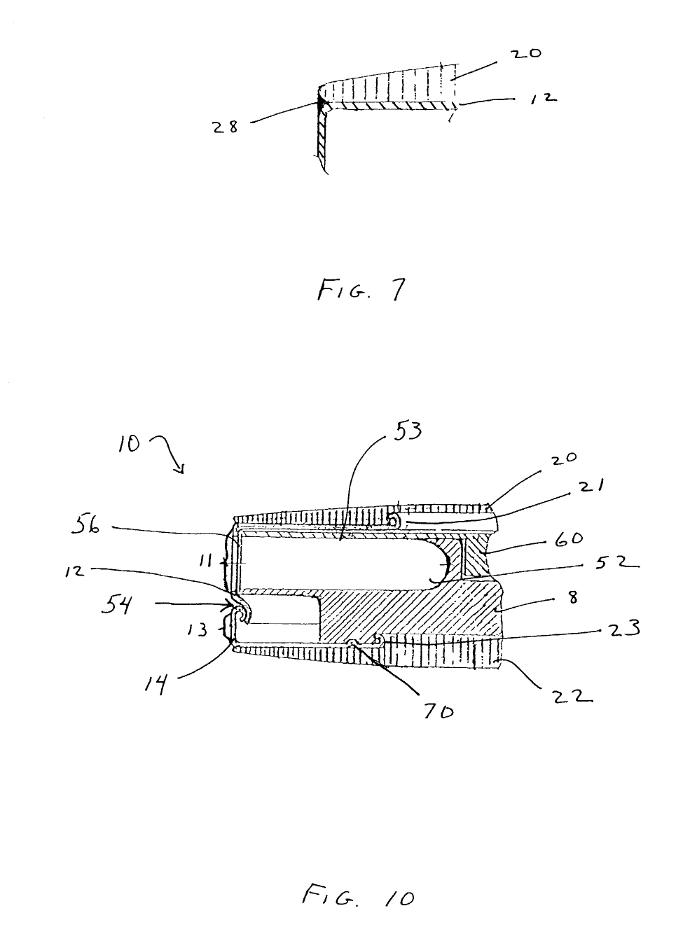

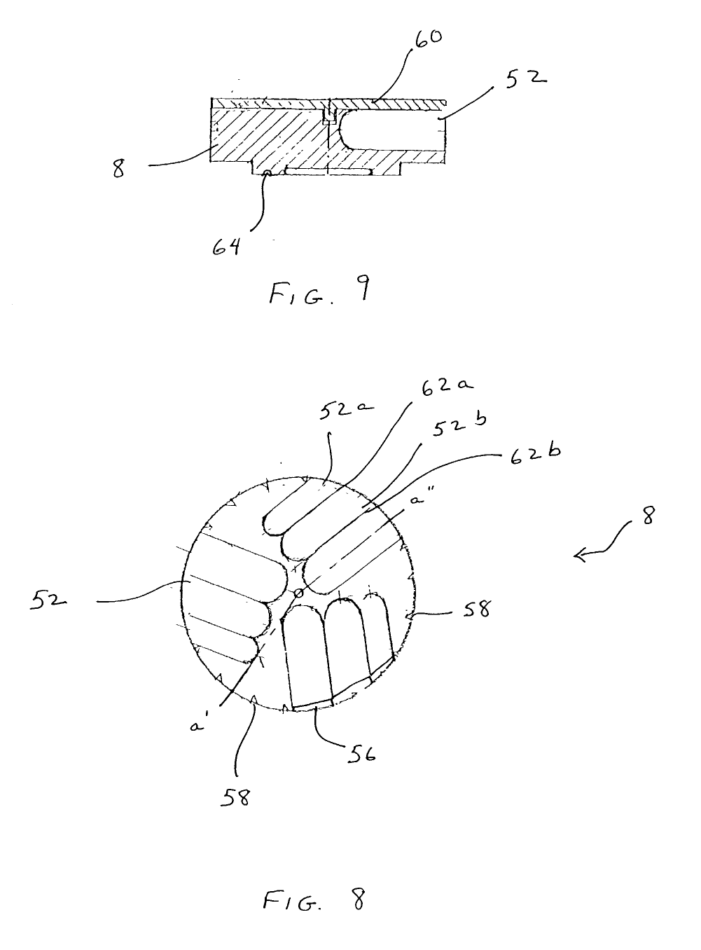

FIG. 1 depicts a multiple dispensing container 10 with three component parts: an upper container unit section 12, a lower container unit section 14 and a container insert 8. The figure depicts the upper container unit section 12 viewed from above, and the lower container unit section 14 viewed from below. When assembled, however, the container insert 8 may be disposed within the upper container unit section 12 and the lower container unit section 14, with each of these sections external to the container insert 8 and with each of these sections adapted for snap-fitting together. The upper container unit section 12 and the lower container unit section 14 may be releasably fitted together to form an external housing (not shown) that encases the container insert 8. As can be seen in this figure, the container insert 8 may be separated into a plurality of cavities 52, each cavity 52 having an exit aperture 56 through which the contents of the cavity 52 may exit. The exit apertures 56 may also be used to fill the cavities 52 with contents. Access to the cavities 52 through their respective exit apertures 56 is achieved in certain embodiments by aligning the exit aperture 56 with the upper dispensing opening 24 in the upper container unit section 12 and/or by aligning the exit aperture 56 with the lower dispensing opening 26 in the lower container unit section 14, as will be described in more detail below. Each cavity 52 may have an exit aperture 56 extending through an outer circumferential aspect 9 of the container insert 8, the exit aperture 56 being alignable with the dispensing opening in one or both components of the external housing. In certain embodiments, either the upper container unit section 12 or the lower container unit section 14 may bear the dispensing opening with which the exit aperture 56 is to be aligned. In these embodiments, the component not bearing the dispensing opening will have a lateral profile that does not obstruct the dispensing opening of the other component. An example of such an embodiment is depicted in FIGS. 3 and 4. If the exit aperture 56 of the container insert 8 is not aligned with appropriate dispensing openings, the contents of the respective cavity 52 remains contained therein, so that the cavity 52 is closed. When the three components described above are fitted together, they form an individual dispensing unit, described in more detail below.

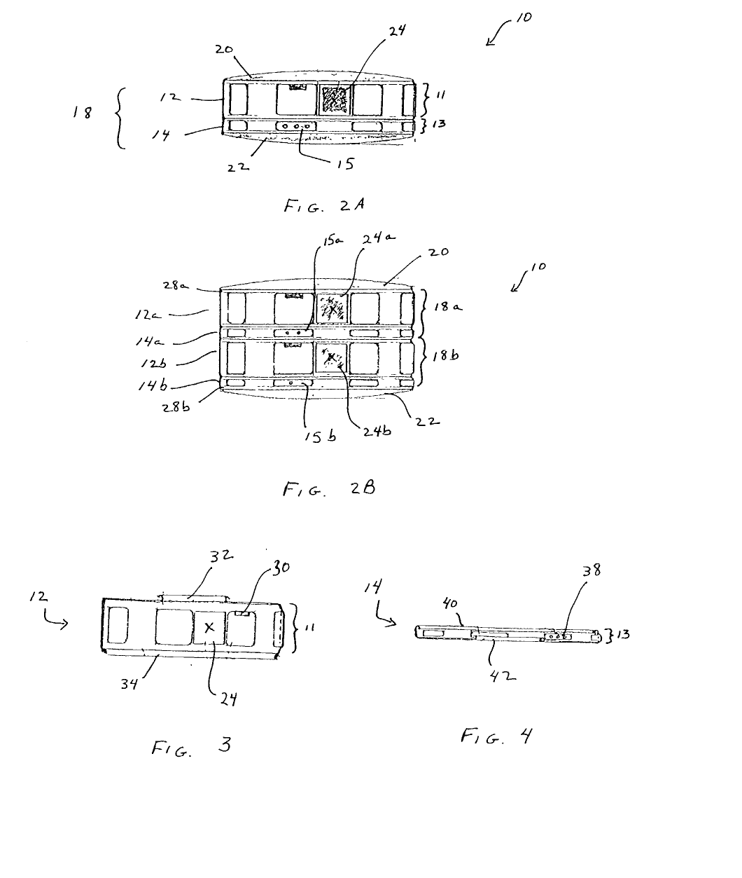

FIGS. 2A and 2B show a side view of the external aspect of embodiments of a multiple dispensing container 10. A multiple dispensing container 10 may include one or more individual dispensing units 18, each individual dispensing unit 18 having an upper container unit section 12 releasably attached to a lower container unit section 14 as shown in this figure. As described above, each individual dispensing unit 18 may also contain within it a container insert (not shown). Each individual dispensing unit 18 may be available for stacking on top of another individual dispensing unit 18, as shown in FIG. 2B. A multiple dispensing container 10 may further include an upper cover 20 and a lower cover 22. In the depicted embodiment, a dispensing opening 24 is provided in the upper container unit section 12. In this embodiment, the upper container unit section has a lateral profile 11, and the lower container unit section has a lateral profile 13. The lateral profile 13 of the lower container unit 14 is sufficiently low that it does not obstruct the dispensing opening 24 of the upper container unit section 12 from aligning with the exit aperture (not shown) on the container insert (not shown) so that the contents thereof may exit therefrom. If the lower container unit section 14 has a higher lateral profile 13, the lower container unit section 14 may have a dispensing opening (not shown) that lines up with the dispensing opening 24 on the upper container unit section 12, with both dispensing openings further aligning with the exit aperture of the container insert so that the contents of the container insert may exit therefrom. In the depicted embodiment, the dispensing opening 24 may be released or closed by rotating the upper container unit section 12 or the lower container unit section 14 relative to the container insert (not shown) and its exit apertures. In certain embodiments the upper unit 12 may be rotated while the lower unit 14 remains stationary, or vice versa. In other embodiments, both units 12 and 14 may be rotated in opposite directions relative to each other. An integrated locking system (not shown) may be incorporated so that the upper unit 12 and/or the lower unit 14 can rotate in only one direction. The opening and closing positions for the dispensing opening 24 may be fixed or identified by a stop location (not shown). These opening and closing positions in certain embodiments may be perceived by touch by means of a special embossing pattern 15, useful, for example, for the visually impaired. As used herein, the term “embossing pattern” or “embossing” may include any tactilely perceptible pattern, whether embossed, engraved, etched, attached as a separate unit, or formed in any other way, as would be appreciated by those of ordinary skill in the art. In certain embodiments, the embossing for the upper or lower container units may be designed to convey tactile information, for example, for the visually impaired. In certain embodiments, embossing may function to enhance the graspability or manipulability of the device. The embossing may also have an ornamental function.

FIG. 2B shows in more detail a stack arrangement of two individual dispensing units 18a and 18b to form a multiple dispensing container 10. For each individual dispensing unit 18a and 18b, an upper container unit section 12a and 12b and a lower container unit section 14a and 14b are shown. Each individual dispensing unit 18a and 18b has its own dispensing opening 24a and 24b, and each may have within it its own container insert (not shown) An upper cover 20 and a lower cover 22 are provided for the multiple dispensing container 10, the upper cover 20 covering the top of the individual dispensing unit 18a, and the lower cover 22 covering the bottom of the lower individual dispensing unit 18b. As shown in this figure, an annular ring 28a may be interposed between the upper cover 20 and the top of the upper individual dispensing unit 18a. The annular ring 28a may be used to provide additional structural support, to facilitate connection of the components, to increase visibility of the device or its components, to enhance visual appeal or to add other functionality. Similarly, and annular ring 28b may be interposed between the lower cover 22 and the bottom of the lower individual dispensing unit 18b. The annular rings 28a and 28b may be made of metal, enamel, resin, plastic or other materials familiar to skilled artisans. Embossing patterns are shown at 15a and 15b. While this figure illustrates only two individual dispensing units stacked together, any number of units may be stacked in similar manner.

As shown in FIGS. 2A and 2B, the individual dispensing unit 18 may include two specially shaped or punched external drawn parts, the upper container unit section 12 and the lower container unit section 14, which can be made of various materials, including plastic, or metals such as painted and/or printed tinplate or aluminum. These two parts can be disconnected for example by a snap-rolling action, and connected again for refilling. Owing to their external shape they can be connected together with other identical dispensing units 18 or with other containers having the same diameter. Each individual dispensing unit 18 may contain a container insert (not shown), each container insert capable of being filled with different substances or quantities, and capable of having different inner configurations, with the set of individual dispensing units 18 being assembled to form one multiple dispensing container 10. The multiple dispensing container 10 may be disassembled, for example, for refilling of individual dispensing units 18 or for transferring an individual dispensing unit 18 to another multiple dispensing container 10.

FIG. 3 depicts a side view of an upper container unit section 12. The upper container unit section 12 may have an opening 24 for filling and removal, an embossing pattern 30 to facilitate grasping and to provide tactile clues for operation, for example by a visually impaired person, and upper and lower adapters 32 and 34 to facilitate connection to a lower container unit section 14 or to a cover (not shown). Such adapters 32 and 34 enable a user of a container 10 to readily snap together or apart its components. The upper container unit section 12 of this figure has a lateral profile 11 that extends to cover the lateral aspect of the container insert (not shown). Accordingly, in the depicted embodiment, the upper container unit section is provided with the opening 24 that lines up with the exit opening (not shown) in the container insert so that the contents of the container insert may exit or may be inserted. An embossing pattern 30 may be provided to assist grasping or to facilitate use, for example by the visually impaired.

FIG. 4 depicts a side view of a lower container unit section 14. As with the upper container unit section 12 shown in the previous figure, the lower container unit section 14 may have an embossing pattern for permitting tactile recognition and may also have upper and lower adapters 40 and 42 for snap assembly and disassembly. In the depicted embodiment, the lower container unit section 14 has a lateral profile 13 that does not extend to cover the lateral aspect of the container insert (not shown). In this embodiment, no opening is required, because this lateral profile 13 would not impede the egress of contents from the container insert. In other embodiments, where the lateral profile 13 would cover the lateral aspect of the container insert, an opening may be provided that lined up with the exit opening in the container insert. Depending on the lateral profile for the upper container unit, the opening in the lower container unit may provide the only opening that need be aligned with the exit opening in the container insert. If the upper container unit has a high lateral profile, as shown in FIG. 3, and the lower container unit 14 also has a high lateral profile 13, each container unit may be provided with an opening that lines up with the other and that both line up with the exit opening in the container insert

FIG. 5 depicts a top view of the upper container unit section 12 having an embossing pattern 30 and having an opening 24 that can be aligned with an exit opening in the container insert (not shown). As previously described, the container insert resides within the mated unit of upper container unit section 12 and lower container unit section 14. In certain embodiments, the upper container unit section 12 may also have a latching mechanism 44 to permit rotation of the upper container unit section 12 in only one direction. As shown in this figure, the latch may be formed as an indentation that mates with a counterpart protrusion on an adjacent component. In certain embodiments, the latch and protrusion may form an integrated locking system as previously described.

FIG. 6 shows the upper cover 20 and the lower cover 22 of a dispensing container. These components also may be fabricated from plastic, enamel, resin, metal, or other materials familiar to skilled artisans. Each cover has an adapter 48 and 50 to facilitate snap-on assembly and disassembly of a dispensing container. The adapters 48 and 50 are formed to meet with adapters on the upper or lower aspects (respectively) of adjacent components such as the upper container unit section 12 for the lower container unit section 14.

FIG. 7 shows in more detail a cross-section of a dispensing container, the cross-section being taken following the dotted lines x and y on FIG. 2A. This detail view shows an annular ring 28 disposed about the circumference of the dispensing container, here interposed between the top cover 20 and the upper dispensing container unit 12. The annular ring 28 may be provided at various locations circumferentially around the dispensing container, for example, between the lower dispensing container unit and its cover. As previously described, the annular ring 28 may serve a number of functions, including providing additional structural support, facilitating connection of components, increasing visibility of the dispensing container, and enhancing its visual appeal.

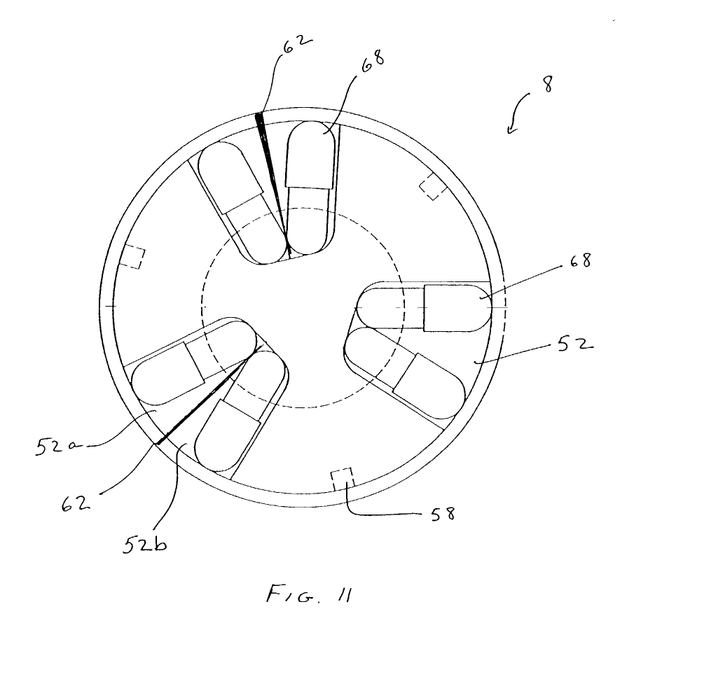

FIG. 8 provides a top view of an embodiment of a container insert 8 showing aspects of its internal configuration. A plurality of cavities 52 are disposed within the container insert 8. These cavities 52 may be disposed radially as illustrated in this figure. The cavities may be formed so that their tops are open, to be closed off with, for example, a removable cover or set of covers; in other embodiments, the cavities may be formed within the substance of the container insert 8 so that each cavity 52 is formed with its own roof, floor and walls. In certain embodiments, where the cavities 52 have open tops, the cavities 52 may be filled from above and then closed off by properly positioning the removable cover or set of covers. Cavities 52 may have capacities that are equal to or different from each other. In certain embodiments, the cavities 52 are formed as part of the container insert 8, each thus having a fixed and preselected volume. In other embodiments, the container insert 8 may be provided with removable or interchangeable plastic inserts 62a and 62b that divide a single cavity 52 into a plurality of the sub cavities 52a, 52b, and 52c. In certain embodiments, the container insert 8 may be equipped with a removable cover that has radially disposed divider walls (not shown) acting in the same way as the plastic inserts that divide a single cavity into a plurality of sub cavities. In this way, the inner configuration of an individual container insert 8 may be determined by the inclusion of an exchangeable insert, for example, one made of plastic. For example, a container insert 8 may be constructed having cavities sized to accommodate a specific number of capsules of known sizes. The container insert 8 may further include latch notches 58 to regulate the alignment of the exit apertures 56 of the cavities 52 with a dispensing opening (not shown) in an external component such as the upper container unit section or the lower container unit section, as described above. The exchangeable container insert 8 may also be connected to one of the two external container parts or may be formed as a separate unit or set of units. The container insert 8 may further be divided into one or several compartments, depending on the application. In this way, maximum flexibility of cavity and sub cavity configuration may be attained.

FIG. 9 show a cross-section taken along line a′-a″ in FIG. 8. This figure shows a removable cover 60 adapted to fit, for example by snap fit, over the container insert 8. The cover 60 functions to close off the open top of the cavity 52 that has been prepared in the container insert 8. As previously described, the removable cover 60 may have one or more radially disposed divider walls (not shown) capable of dividing the cavity 52 into sub cavities as desired by a particular application. The removable cover 60 permits a cavity 52 to be filled from above. In certain embodiments, the removable cover may itself the initially filled, for example by insertion of pills or other contents between its divider walls while the cover is upside down on a flat surface. The container insert 8 may then be turned upside down and fitted to the cover 60 so that its cavity 52 is divided by the divider walls into sub cavities, and so that the preselected number of pills or other contents are disposed properly in each sub cavity. After snap fitting the two components together, the device may optionally be returned to its upright or other desired position so that the cover 60 then rests atop the container insert 8. As shown in this figure, a latch 64 may be provided on the undersurface of the upper container unit, or on any other surface thereof, as will be appreciated by those of ordinary skill in the art. This latch 64 may serve to prevent back-rotation or to align a particular cavity 52 with a dispensing opening (not shown).

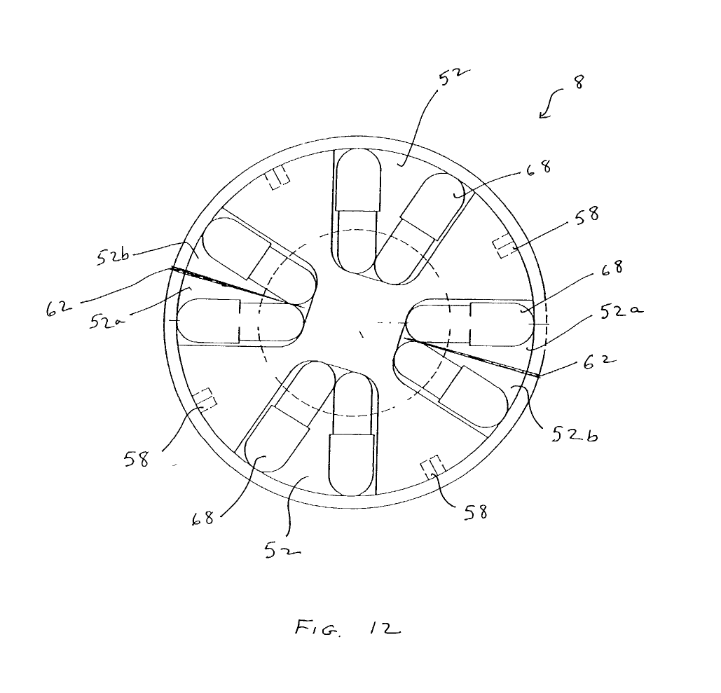

FIG. 10 shows a cross-section of a multiple dispensing container 10 with its external component parts, including an upper container unit section 12, a lower container unit section 14, an upper cover 20 and a lower cover 22. Each cover is held in place by an adapter that permits snap-fit of the cover to the underlying component. An adapter 21 permits snap-fit of the upper cover 20 to the upper container unit section 12. A lower adapter 23 permits snap-fit of the lower cover 22 to the lower container unit section 14. The upper container unit section 12 and the lower container unit section 14 intersect at a snap-fit intersection 54. As shown in this embodiment, various snap-fit connections permits easy assembly and disassembly of the external components. Inserted within the multiple dispensing container 10 is a container insert 8. In the depicted embodiment, a cavity 52 is shown having an open top 53. This open top 53 is closed in the depicted embodiment by a removable cover 60. The cavity 52 has an exit aperture 56. Due to the high lateral profile 11 of the upper container unit section 12, this latter structure will be provided with openings (not shown) that may be lined up with the exit aperture 56 so that the contents (not shown) of the cavity 52 may be inserted or removed in accordance with the particular application. It will be noted that the lower container unit section 14 has a low profile 13, so does not require an opening that is alignable with the exit aperture 56. As previously described, the external components may be made from a variety of materials. Desirably, the upper container unit section and the lower container unit section may be made from metal, for example, a tin-plated sheet metal. In the depicted embodiment, an antirotational latching system 70 is provided on the bottom of the lower container unit section 14 where it intersects with the lower cover 22. It is understood that a variety of antirotational latching systems may be provided in various parts of the multiple dispensing container to effect the desired antirotational function.

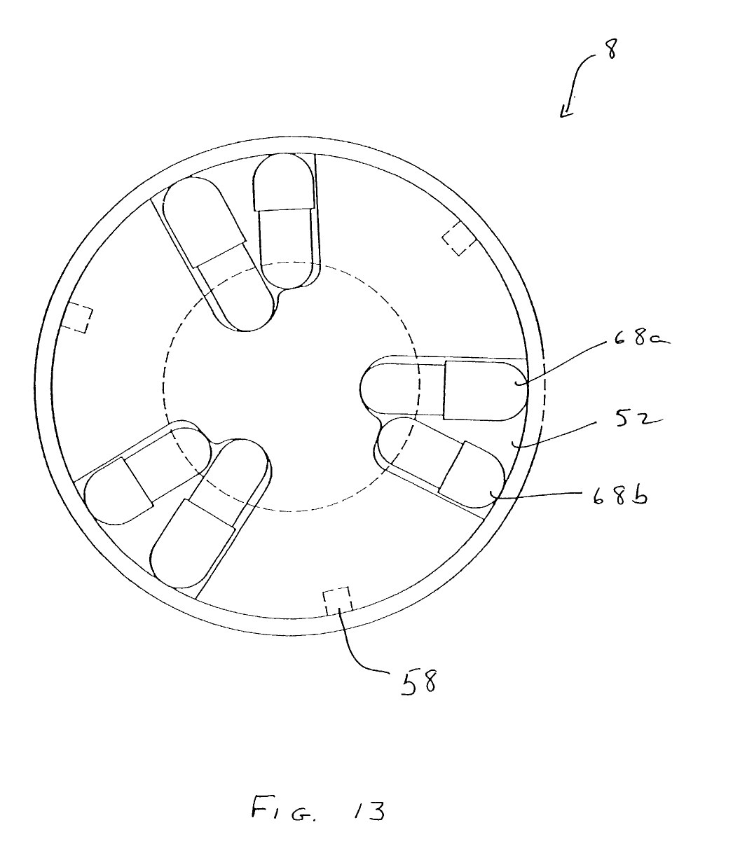

A variety of configurations of cavities 52 within container inserts 8 can be arranged. Exemplary embodiments are depicted in FIGS. 11-13. Each of these figures shows a latch notch 58 previously described to prevent back rotation and/or to align a cavity 52 with a dispensing opening (not shown). Other latch mechanisms may be incorporated in the design of the container insert 8, as previously described.

As shown in FIGS. 11 and 12, an container insert 8 may be provided with a plurality of cavities 52, certain of which may be divided into sub cavities 52a and 52b by divider walls 62. Each sub cavity may contain an individual pill 68. A cavity 52 may also contain one or more pills 68. Although each pill 68 in these figures appears similar, it is understood that pills or other contents may be varied in their size or shape.

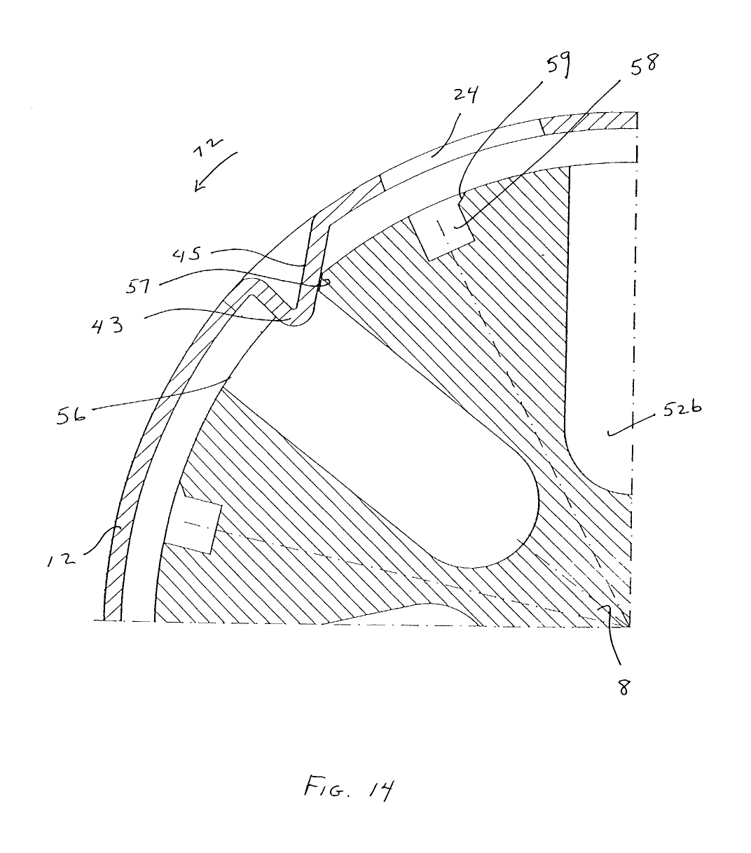

An example of varying pill size is provided at FIG. 13. In this figure, pills 68a and 68b are shown disposed within a cavity 52, the contour and volume of which has been adapted to hold these two different-sized pills. Other arrangements may be readily envisioned by those of ordinary skill in the art. While FIG. 13 does not show any divider walls within a cavity 52, it will be understood that such divider walls may be provided, as previously described.

FIG. 14 shows in more detail an example of a latching mechanism designed to restrict the motion of the container insert 8 relative to an external component of the multiple dispensing container, either the upper container unit section 12 as shown in this figure, or the lower container unit section 14 as previously described. The effective direction of rotation 72 for the container insert 8 relative to the upper container unit section 12 in the depicted embodiment is counterclockwise. To permit this rotation and further to affix the container insert 8 relative to the upper container unit section 12, a latching mechanism may be provided such as that shown in this figure. The latching mechanism shown in this figure has two parts: a protrusion 43 formed on the inner aspect of the upper container unit section 12 and a notch 58 formed on the outer aspect of the container insert 8. The protrusion 43 may have a sloping edge 45 that permits the protrusion 43 to slide out of the notch 58 when force is applied in the appropriate clockwise or counterclockwise direction. Furthermore, the exit aperture 56 also may have a sloping edge 57 that permits the protrusion 43 with its sloping edge 45 more readily to disengage from the exit aperture 56 when force is applied in the appropriate direction. When the protrusion 43 inserts itself into the notch 58, this fixes an alignment between the exit aperture 56 and the dispensing opening 24 of the upper container unit section 12. To facilitate the temporary deformations required for engagement and disengagement of the protrusion 43 with either the exit aperture 56 or the notch 58, the protrusion 43 may be formed of a relatively deformable material, for example a flexible metal or plastic. Alternatively, the container insert 8 may be made of a material whose rigidity is sufficient to permit the necessary temporary deformations. Other arrangements of a latching mechanism to permit forward rotation and to prevent back rotation may be readily envisioned by those of ordinary skill in the art. In certain embodiments, the protrusion 43 may be located on the container insert 8 with the notch 58 being located on the external component. Either the upper or the lower container unit sections may bear the external part of the latching assembly. Other types of latches will be familiar to skilled artisans. Preferably, the open and closed positions are securely locked using the latching mechanism. In other embodiments, a locking system may be used to replace the latches shown, so that back-rotation is relatively permanently prevented, or so that forward rotation may only be carried out with the unlocking of a lock. For example, a programmable timer or other system may be built into the device to govern the availability of the contents of a particular cavity 56. Using such a system, the device may permit advancement of the container insert relative to the external components only on a prescribed schedule, so that the contents of a cavity 56 may not be made available until a preselected time.

To illustrate certain advantages of the multiple dispensing container system, the following example is provided. For example, three different products are to be used in a 1-2-3 cycle during a period of 4 days. These three different products may be packaged in units of four in three individual dispensing units which can be connected together to form a multiple dispensing container.

### Exemplary Dispensing Operation

1. The OPEN and CLOSED positions are reached and locked in place in the provided fixed position by ROTATING.

2. The cycle begins in the CLOSED (initial) position, which is visible. Filling is performed by means of a notch in the lower part of the container. The container is locked in place.

3. Counter-rotation of the upper and lower parts leads to the next catch position, characterized by a bump on the smooth gripping edge of the lower part, thus arriving at the first OPEN position. The container is again locked in place.

4. The container is CLOSED by again counter-rotating the upper and lower parts, leading to the next catch position. The container is again locked in place.

5. The procedure is repeated. The individual positions for the OPEN position may be characterized by different numbers of raised bumps.

### Exemplary Assembly Operation

1. PULL OFF

2. PUT TOGETHER

1. Rotate the container to the INITIAL POSITION and screw down the upper and lower parts.

2. Bring the catch from the upper part together with the continuous notch from the lower part, and press the upper and lower parts together with light pressure.

Other uses for the multiple dispensing container system as described herein include: an additional use for an integrated pill separator with storage compartment for one-half of a cut pill; an additional use for releasably joining several individual containers; an additional use for a turnstile with a built-in programmable timer system.

Certain changes may be made in the above constructions without departing from the scope of the invention. It is intended that all matter contained in the above description or shown in the accompanying drawings be interpreted as illustrative and not in a limiting sense. It is also to be understood that the following claims are to cover all generic and specific features of the invention described herein, and all statements of the scope of the invention which, as a matter of language, might be said to fall therebetween.

While certain embodiments have been shown and described in detail herein, various modifications, improvements and alternate embodiments will be readily apparent to those of skill in the art. Accordingly, the spirit and scope of the present invention is to be limited only by the following claims.

1. A multiple dispensing container for dispensing small articles, comprising:
an individual dispensing unit having an upper container unit section, a lower container unit section and a container insert, the upper container unit section and the lower container unit section being releasably attachable to each other to form an external housing, the external housing having at least one dispensing opening, and the container insert being removably insertable into the external housing, the container insert having a plurality of cavities for retaining small articles, with a preselected number of small articles being disposed in each cavity, each cavity having an exit aperture extending through an outer circumferential aspect of the container insert, the exit aperture being alignable with the at least one dispensing opening for exit of at least one small article from the cavity.

2. The multiple dispensing container of claim 1, wherein the external housing is rotatable relative to the container insert.

3. The multiple dispensing container of claim 2, further comprising a latching mechanism to direct rotation of the external housing relative to the container insert in a single direction.

4. The multiple dispensing container of claim 1, comprising a plurality of individual dispensing units.

5. The multiple dispensing container of claim 1, wherein at least one of the upper container unit section and the lower container unit section has an embossing.

6. The multiple dispensing container of claim 1, further comprising a top cover removably attachable to the upper container unit section and a bottom cover removably attachable to the lower container unit section.

7. The multiple dispensing container of claim 1, further comprising an annular ring insertable between an individual dispensing unit and at least one of the top cover and the bottom cover.

8. The multiple dispensing container of claim 1, wherein at least one cavity has an open top.

9. The multiple dispensing container of claim 8, wherein the container insert is removably coverable with a cover, the cover having at least one radially disposed divider wall insertable into the at least one open-topped cavity to divide it into subcavities.

11. The multiple dispensing container of claim 1 wherein at least one of the plurality of cavities is dividable into subcavities.
